(19) United States
(12) Patent Application Publication
(10) Pub. No.: US 2021/0256013 A1
(43) Pub. Date: Aug. 19, 2021

(54) BLOCKCHAIN-BASED METHODS AND APPARATUSES FOR RECORDING STRUCTURED WORK

(71) Applicant: Advanced New Technologies Co., Ltd., George Town (KY)

(72) Inventor: Xinying Yang, Hangzhou (CN)

(73) Assignee: Advanced New Technologies Co., Ltd., George Town (KY)

(21) Appl. No.: 17/163,333

(22) Filed: Jan. 29, 2021

Related U.S. Application Data
(63) Continuation of application No. PCT/CN2019/116199, filed on Nov. 7, 2019.

(30) Foreign Application Priority Data
Dec. 28, 2018 (CN) 201811622784.6

(51) Int. Cl. G06F 16/23

(52) U.S. Cl. CPC G06F 16/2379

(57) ABSTRACT

Blockchain-based methods and apparatuses for recording a structured work are disclosed. One method comprises: identifying, by a client device, one or more components of a structured work created by a user; for each component of the one or more components: calculating, by the client device, a hash value of the component; constructing, by the client device based on the hash value, a component blockchain transaction corresponding to the component, and sending, by the client device, the component blockchain transaction to a blockchain network to be recorded; and recording, by the client device, a correspondence between the component and the structured work.

### CROSS-REFERENCE TO RELATED APPLICATIONS

This application is a continuation of PCT Application No. PCT/CN2019/116199, filed on Nov. 7, 2019, which claims priority to Chinese Patent Application No. 201811622784.6, filed on Dec. 28, 2018, and each application is hereby incorporated by reference in its entirety.

### TECHNICAL FIELD

Examples of the present specification relate to information technology, and in particular to blockchain-based methods and blockchain-based apparatuses for recording a structured work.

### BACKGROUND

A structured work refers to a file having contents assembled from several components. For example, a musical work edited with a sequencer is a structured work, which is a combination of several audio track files (as component contents). For another example, texts are generally structured works, which are composed of several paragraphs (as component contents).

In practice, in a process of creating a structured work, a user generally creates a content of each component in sequence. After all of the component contents are created, the user can record the whole structured work which assembled from the component contents to a blockchain. That is, the user submits, via a client device, a blockchain transaction containing a hash value of the structured work, for nodes of the blockchain network to perform distributed recording.

For example, when a user creates a text, the user generally creates each paragraph one by one from beginning to end. After the user has created all the paragraphs, it means that the creation of the text has been completed. At this time, the user can record the whole text on the blockchain.

Since the blockchain transactions constructed by the user via the client device generally contains identity information of the user, when the user packages the structured work blockchain transaction and publishes the same on the blockchain, it can prove that the user has the copyright of the structured work. However, in the process of creating a structured work (that is, before creation of the structured work has been completed), the component contents that have been created are at risk of being plagiarized. In this case, it is difficult to prove that the user possesses the copyright of the component content in practice.

### SUMMARY

In order to alleviate the problem that it is difficult to prove that the user possesses the copyright of the created component content before the creation of the structured work is completed, some examples of the present specification provide blockchain-based methods and blockchain-based apparatuses for recording a structured work. The technical solutions are as follows.

According to a first aspect of some examples of the present specification, a blockchain-based method for recording a structured work is provided, including:

in a process of a user creating a structured work via a client device, by the client device:

for each of the component contents created by the user, obtaining the component content and calculating a component hash of the component content;

based on the component hash, constructing a component blockchain transactions corresponding to the component content, and sending the component blockchain transactions corresponding to the component content to a blockchain network to be recorded; and

establishing and storing a correspondence between the component content and the structured work.

According to a second aspect of some examples of the present specification, an blockchain-based apparatus for recording a structured work is provided, including:

an calculation obtaining module configured to, in a process of a user creating a structured work via a client device, for each of the component contents created by the user, obtain the component content and calculate a component hash of the component content;

a constructing-sending module configured to, based on the component hash, construct a component blockchain transactions corresponding to the component content, and send the component blockchain transactions corresponding to the component content to the blockchain network to be recorded;

an storage enablement module configured to establish and store a correspondence between the component content and the structured work.

With the technical solutions provided by some examples of the present specification, in a process of a user creating a structured work via a client device, the client device can obtain each of the component contents created by the user, and perform blockchain recording for each of the component contents obtained in a timely manner. In addition, the client device can also establish and store a correspondence between the each of the component contents and the structured work. As such, for the user, in the process of creating a structured work, although the whole structured work has not been recorded on the blockchain, component contents that are used to assemble the structured work can be recorded on the blockchain in a timely manner. On one hand, this is equivalent to incrementally completing blockchain recording of the structured work during the process of creating the structured work by the user. On the other hand, in the process of the user creating the structured work, once each of the component contents is generated, the component content can be recorded in a timely manner, which can provide evidence for the user to claim copyright on the individual component content.

It should be understood that the above general descriptions and the below detailed descriptions are merely illustrative and explanatory, and are not intended to limit embodiments of the present specification.

In addition, any of the embodiments of the present specification does not need to achieve all the above-mentioned effects.

### BRIEF DESCRIPTION OF THE DRAWINGS

In order to more clearly describe the technical solutions in some examples of the present specification or the existing technology, the following will briefly introduce the drawings to be used in the description of some examples or the existing technology. Apparently, in the following description, the drawings are only some of some examples described in the present specification. For those ordinarily skilled in the art, other drawings can be obtained based on these drawings.

FIG. 1 is a schematic flowchart illustrating a blockchain-based method for recording a structured work according to an example of the present specification.

FIG. 2 is a schematic diagram illustrating a tree structure of a text according to an example of the present specification.

FIG. 3 is a schematic diagram illustrating a structure of a hash tree corresponding to a text according to an example of the present specification.

FIG. 4 is a schematic diagram illustrating an updated tree structure according to an example of the present specification.

FIG. 5 is a schematic diagram illustrating a structure of an updated hash tree according to an example of the present specification.

FIG. 6 is a schematic diagram illustrating another updated tree structure according to an example of the present specification.

FIG. 7 is a schematic diagram illustrating a structure of another updated hash tree according to an example of the present specification.

FIG. 8 is a schematic diagram illustrating a Merkle tree corresponding to a musical work according to an example of the present specification.

FIG. 9 is a block diagram illustrating a blockchain-based apparatus for recording a structured work according to an example of the present specification.

FIG. 10 is a block diagram block a computer device equipped with the apparatus according to the example of the present specification.

### DETAILED DESCRIPTION

In order to enable those skilled in the art to better understand the technical solutions in some examples of the present specification, the technical solutions in some examples of the present specification will be described in detail below with reference to the drawings in some examples of the present specification. Clearly, the described examples are only a part of some examples in the present specification, rather than all the examples. Based on some examples in the present specification, all other examples obtained by a person of ordinary skill in the art should fall within the scope of protection.

The technical solutions provided by some examples of the present specification will be described in detail below with reference to the drawings.

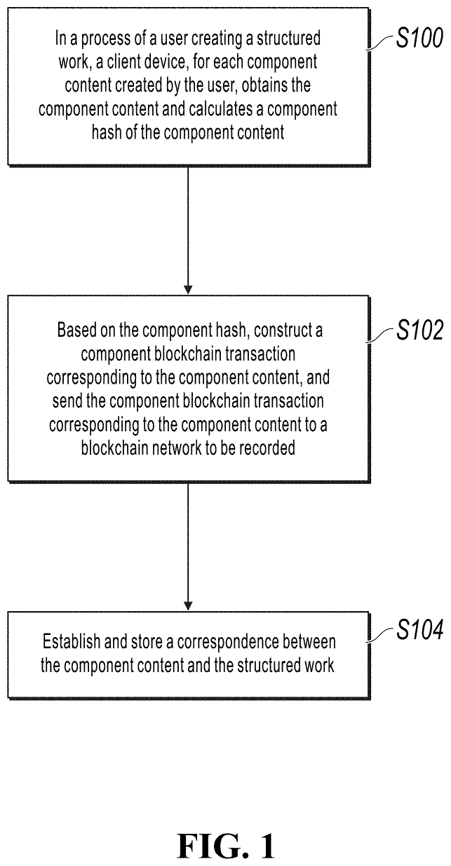

FIG. 1 is a schematic flowchart illustrating a blockchain-based method for recording a structured work according to an example of the present specification, including the following steps:

At S100, in a process of a user creating a structured work via a client device, for each of the component contents created by the user, the client device obtains the component content and calculates a component hash of the component content.

In some examples of the present specification, transaction logics used to implement the method shown in FIG. 1 are deployed in a corresponding client device of the blockchain network. Users generally have to log in to the client device, to create structured works via the client device.

The structured works described herein include, but are not limited to, texts written in a structured way and musical works edited with a sequencer. Structured texts can be thesis, chapter literary works, or the like. The musical works edited with a sequencer can specifically be a musical work in a Musical Instrument Digital Interface (MIDI) format. Musical works in MIDI format are often formed by combining multiple audio track files. When creating a MIDI musical work, a user generally edits several audio tracks separately to obtain several audio track files, and then combines the several audio track files into a musical work.

When the structured work is a text, the corresponding component content can be each paragraph of the text. When the structured work is a musical work, the corresponding component content can be each audio track file corresponding to the text.

In some examples of the present specification, in a process of creating a structured work via a client device, every time the user has completed a component content, the user can instruct the client device to obtain the component content for subsequent processing (steps S102 to 104). In addition, it can also be that the client device monitors the creation process of the user, and whenever the client device monitors that the user has created a component content, the client device obtains the component content for subsequent processing (steps S102 to 104).

In the field of blockchain-based data recording, generally the original data is not recorded, but a hash value of the data is recorded. In some examples of the present specification, for each of the component contents obtained by the client device, the client device generally can calculate a hash value of the component content (referred to as a component hash herein for the convenience of description), and record the component hash to the blockchain.

At S102, based on the component hash, a component blockchain transactions corresponding to the component content is constructed, and the component blockchain transactions corresponding to the component content is send to a blockchain network to be recorded.

As known, for a blockchain network, it is generally necessary to use the data structure of a “transactions” to implement the broadcasting, consensus reaching and recording of data. In some examples of the present specification, for each of the component contents obtained, the client device will construct a component blockchain transactions containing the component hash after obtaining the component hash of the component content, and submit the component blockchain transactions to the blockchain network to be recorded.

Specifically, the client device can send the component blockchain transactions to any node in the blockchain network, and the node will further broadcast the component blockchain transactions to other nodes in the blockchain network. Based on the consensus mechanism, each node in the blockchain network will package the component blockchain transactions into a block and write the same into the blockchain.

It should be noted that in addition to the component hash of the component content, the component blockchain transactions generally also includes identity information of the user. Thus, when the component blockchain transactions is written into the blockchain, it is equivalent to recording evidence for the fact that “the user has created the component content”.

At S104, a correspondence between the component content and the structured work is established and stored.

In some examples of the present specification, in order to make it clear that in the process of creating the structured work, each of the component contents that has been recorded on the blockchain is the component content of the structured work, a correspondence between the component content and the structured work can be established and stored.

In this way, although the component blockchain transactionss corresponding to the component contents of the structured work are recorded in the blockchain as in a distributed manner, the distributed component blockchain transactionss can still be mapped to the structured work, to prove that the user possesses the copyright of the structured work.

Further, after the user completes the creation of the structured work, the client device can also record the structured work to the blockchain.

In addition, the execution sequence of steps S102 and S104 are not limited in the present specification.

Through the method shown in FIG. 1, for the user, in the process of creating a structured work, although the whole structured work has not been recorded on the blockchain, component contents that are used to assemble the structured work can be recorded on the blockchain in a timely manner. On one hand, this is equivalent to incrementally completing blockchain recording of the structured work during the process of the user creating the structured work. On the other hand, in the process of the user creating the structured work, once each of the component contents is generated, the component content can be recorded in a timely manner, which can provide evidence for the user to claim copyright on the individual component content.

In addition, in some examples of the present specification, for each of the component contents of the structured work obtained by the client device, establishing the correspondence between the component content and the structured work can specifically be: assigning a label for the component content. The label corresponding to the component content includes a work identifier of the structured work. Correspondingly, the client device storing the correspondence between the component content and the structured work can specifically be storing the label corresponding to the component content.

In some examples of the present specification, for each of the component contents, a correspondence between the label corresponding to the component content and the transaction hash of the component blockchain transactions corresponding to the component content can also be established and stored.

In the following, detailed description will be given by taking the structured work being respectively a text or a musical work as examples.

1. The structured work is a text.

When the structured work is a text, for each of the component contents, the component content can be a paragraph of the text. The client device assigns a label to the component content, and can take a paragraph path corresponding to the component content which is predetermined by the user as the label corresponding to the component content.

It should be noted here that for a text written in a structured form, the text can be generally divided into chapters, sections, paragraphs, or the like in structure. Paragraphs are generally component contents of a text, and at least one paragraph can be assembled into one section, at least one section can be assembled into one chapter, and chapters are finally assembled into a text. A paragraph path corresponding to a certain paragraph refers to a path composed of an identifier of the paragraph, an identifier of the section to which the paragraph belongs, an identifier of the chapter to which the section belongs, and an identifier of the text to which the chapter belongs.

For example, if a user wants to create a thesis, when the user creates the first paragraph of the first section of the first chapter, the paragraph path predetermined for the currently created paragraph can be txt-1-1-1. Similarly, when the user creates the second paragraph of the first section of the first chapter, the paragraph path predetermined for the currently created paragraph can be txt-1-1-2, and when the user creates the third paragraph of the second section of the second chapter, the paragraph path predetermined for the currently created paragraph can be txt-2-2-3. Of course, those skilled in the art should understand that the text can also have only chapters and no sections, or neither chapters nor sections. The corresponding paragraph path can also be obtained based on the policy described based on the present specification, details are omitted for simplicity.

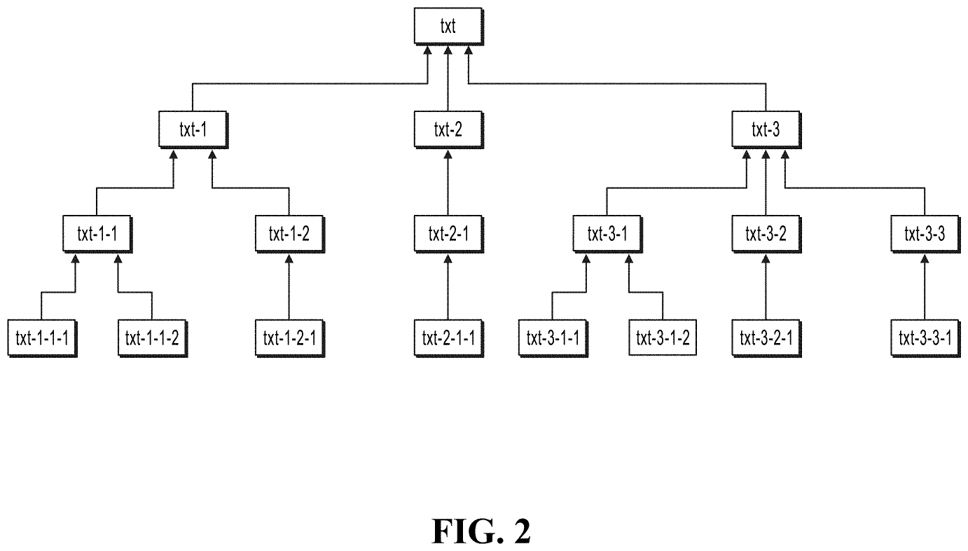

FIG. 2 is a schematic diagram illustrating a tree structure of a text according to an example of the present specification. As shown in FIG. 2, a text txt has 3 chapters. The first chapter txt-1 has two sections (txt-1-1 and txt-1-2), the second chapter has one section (txt-2-1), and the third chapter has three sections (txt-3-1, txt-3-2, txt-3-3). The first section of the first chapter has two paragraphs (txt-1-1-1 and txt-1-1-2), the second section of the first chapter has one paragraph (txt-1-2-1), the first section of the second chapter has one paragraph (txt-2-1-1), the first section of the third chapter has two paragraphs (txt-3-1-1 and txt-3-1-2), the second section of the third chapter has one paragraph (txt-3-2-1), and the third section of the third chapter has one paragraph (txt-3-3-1). It can be seen that the works, chapters, sections, and paragraphs of texts written in structure can be organized into a tree structure.

Further, in some examples of the present specification, a hash tree for characterizing the text can be constructed based on the tree structure of the text. Specifically, after the user completes the creation of the structured work via the client device, the client device can determine the sequence of the component contents in the structured work based on the paragraph paths respectively corresponding to the component contents; based on the sequence of the component contents, sort the component hashes respectively corresponding to the component contents, to obtain a first sequence; based on the first sequence, construct a hash tree; based on the root hash corresponding to the root node of the hash tree, construct a file blockchain transactions; and send the constructed file blockchain transactions to the blockchain network to be recorded.

In the hash tree, the root node corresponds to the structured work, and leaf nodes have one-to-one correspondence to component hashes. For each of the leaf nodes, the path between the root node and the leaf node is consistent with the paragraph path of the component hash corresponding to the leaf node. The paragraph path of the component hash corresponding to the leaf node refers to the paragraph path corresponding to the component content on the leaf node. In other words, the construction process of the hash tree can be: for the tree structure shown in FIG. 2, substituting the component hash corresponding to each paragraph, and then calculating the hash value of each section, the hash value of each chapter, and the hash value of the text txt from bottom to top.

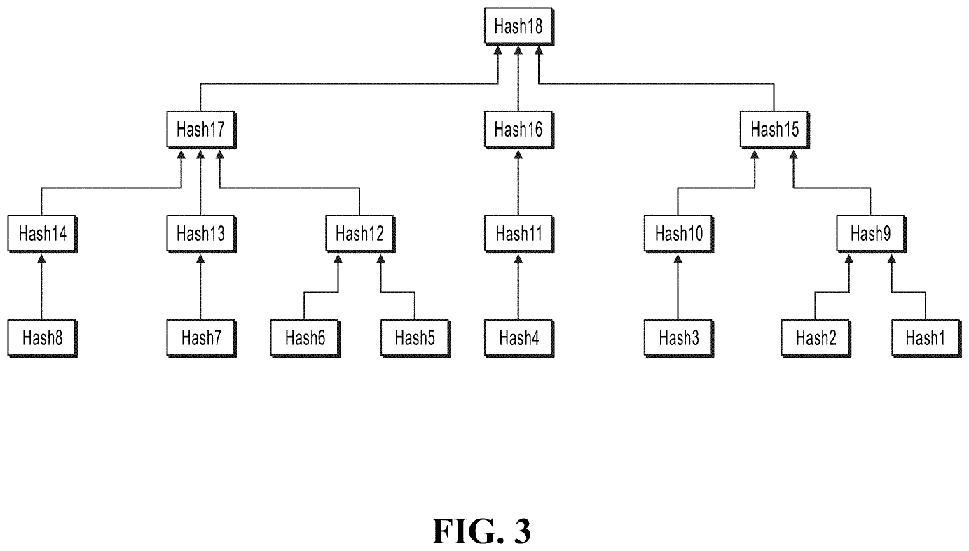

Based on the text shown in FIG. 2, some examples of the present specification provide a hash tree corresponding to the text, as shown in FIG. 3. In the hash tree shown in FIG. 3, the hash value of each parent node is obtained by hashing the hash values of its child nodes. Table 1 below shows the mapping relationship between FIG. 2 and FIG. 3.

TABLE 1

| | |
|---|---|
| txt | hash18 |
| txt-1 | hash15 |
| txt-2 | hash16 |
| txt-3 | hash17 |
| txt-1-1 | hash9 |
| txt-1-2 | hash10 |
| txt-2-1 | hash11 |
| txt-3-1 | hash12 |
| txt-3-2 | hash13 |
| txt-3-3 | hash14 |
| txt-1-1-1 | hash1 |
| txt-1-1-2 | hash2 |
| txt-1-2-1 | hash3 |
| txt-2-1-1 | hash4 |
| txt-3-1-1 | hash5 |
| txt-3-1-2 | hash6 |
| txt-3-2-1 | hash7 |
| txt-3-3-1 | hash8 |

Clearly, the root hash of the hash tree shown in FIG. 3 can uniquely represent the text shown in FIG. 2. Based on the root hash, the file blockchain transactions is constructed and sent to the blockchain network, to implement the recording of the text.

The advantages of representing a text with the hash tree shown in FIG. 3 will be explained below. Since the creation of works is not accomplished in one step, the user can repeatedly modify the text in the process of creating a text. In this case, if the text is represented in other forms than a hash tree, even if the user makes a slight modification to the text, the client device has to perform hash operation on the full text of the text to obtain the hash value of the text, and then construct the file blockchain transactions again based on the hash value of the text.

If the previous hash tree is used to represent the text, only the component hash corresponding to the paragraph modified by the user in the hash tree needs to be replaced, and accordingly, only the hash values related to the modified paragraph in the hash tree need to be updated. For example, referring to FIG. 2, the user modifies txt-3-1-1, and accordingly, only the component hash of txt-3-1-1 needs to be recalculated, and the amount of calculation is rather small. Then, the hash5 corresponding to txt-3-1-1 in the hash tree in FIG. 3 is updated, then, only hash12, hash17 and hash18 need to be updated accordingly.

That is to say, in some examples of the present specification, when the user modifies any of the component contents in the structured work via the client device, the hash tree can be updated based on the component hash of the modified component content. Then, based on the root hash corresponding to the root node of the updated hash tree, a file blockchain transactions is constructed, and the constructed file blockchain transactions is sent to the blockchain network to be recorded.

In addition, sometimes, in the process of creating a text, the user might add paragraphs to the text. Two types of scenarios are shown below.

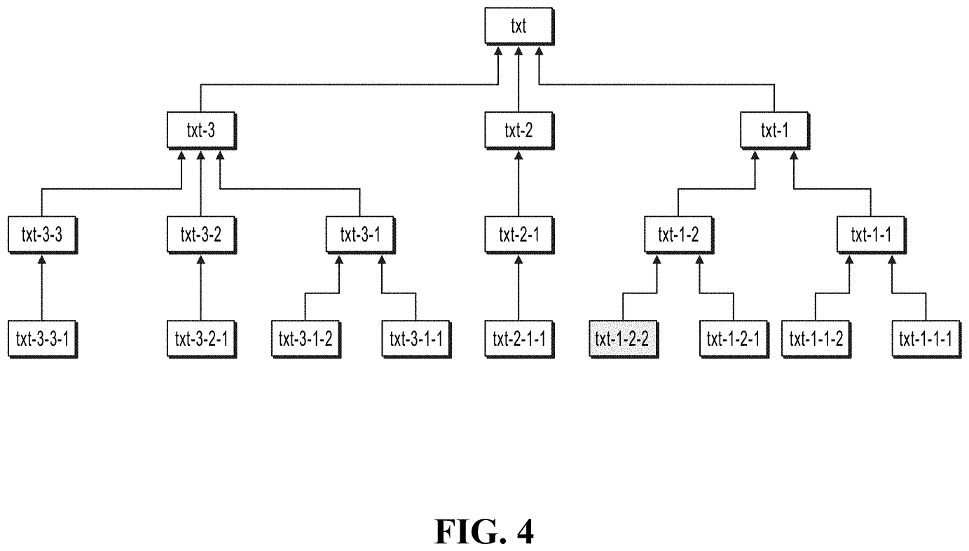

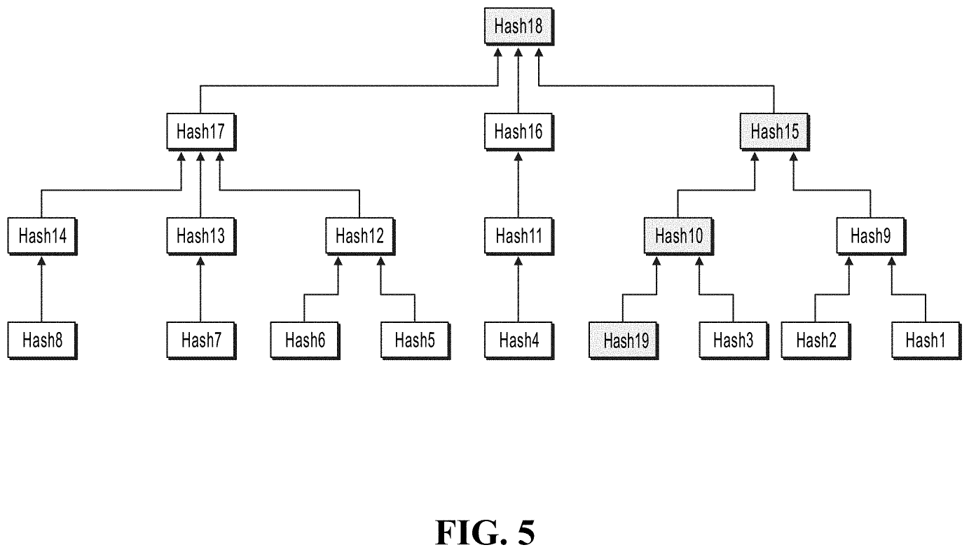

Scenario 1. The user adds a paragraph to the ending part of a certain chapter of the text. In this case, the new paragraph will not destroy the existing paragraph path system. For example, referring to FIG. 2, assume that the user adds a paragraph after the first paragraph of the second section of the first chapter. This paragraph still belongs to the second section of the first chapter, then the tree structure shown in FIG. 2 can be updated to obtain the tree structure shown in FIG. 4. Txt-1-2-2 in FIG. 4 is the newly added paragraph. Correspondingly, the component hash of txt-1-2-2 is calculated and added to the hash tree shown in FIG. 3 to obtain the tree structure shown in FIG. 5. Hash19 in FIG. 5 is the component hash of txt-1-2-2. In addition, hash10, hash15, and hash18 need to be updated accordingly.

Scenario 2. The user inserts a new paragraph between two paragraphs under a certain chapter of the text. In this case, the label (paragraph path) corresponding to the newly added paragraph needs to satisfy a predetermined rule. The predetermined rule can be that the paragraph number of the newly added paragraph is the average value of the paragraph number of the previous paragraph and the paragraph number of the next paragraph.

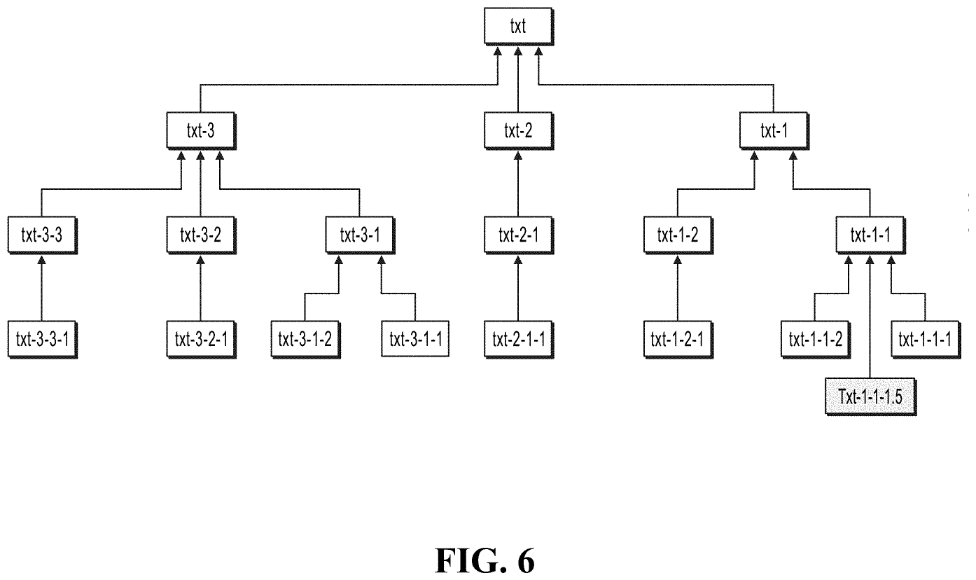

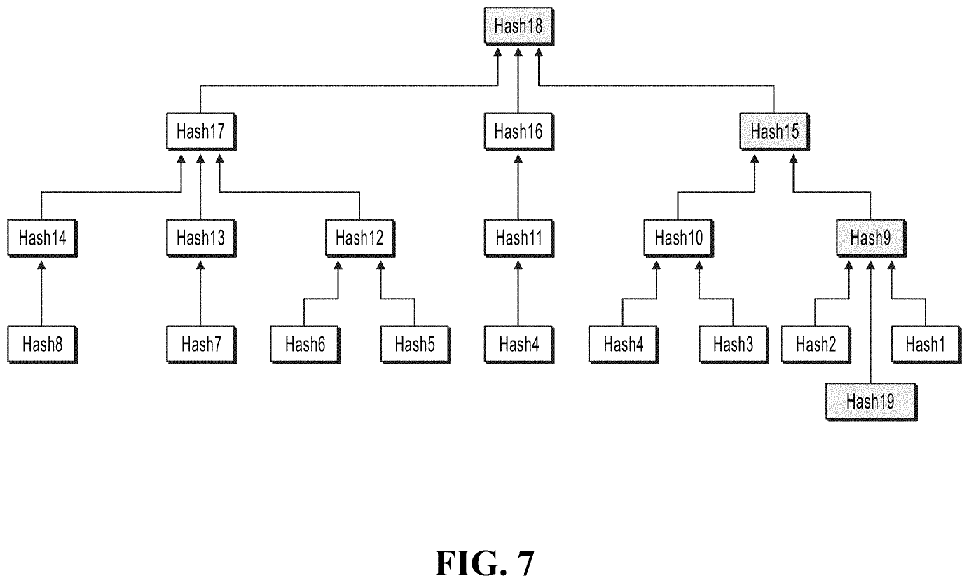

For example, referring to FIG. 2, assume that the user adds a paragraph between the first paragraph of the first section of the first chapter txt-1-1-1 (paragraph number is 1) and the second paragraph of the first section of the first chapter txt-1-1-2 (paragraph number is 2), then the paragraph path corresponding to the newly added paragraph is txt-1-1-1.5, as shown in FIG. 6. Correspondingly, the component hash of txt-1-1-1.5 is calculated and added to the hash tree shown in FIG. 3 to obtain the hash tree shown in FIG. 7. Hash19 in FIG. 7 is the component hash of txt-1-1-1.5. In addition, hash9, hash15, and hash18 need to be updated accordingly.

Combining the above scenario 1 and scenario 2, the client device can perform the following steps.

When the user adds any of the component contents to the structured work via the client device, based on the paragraph path corresponding to the component content which is predetermined by the user, a sequence of the component hash corresponding to the component content relative to each component hash in the first sequence is determined; based on the sequence of the component hash corresponding to the component content relative to each component hash in the first sequence, the component hash corresponding to the component content is inserted to the first sequence; based on the updated sequence, the hash tree is updated; based on the root hash corresponding to the root node of the updated hash tree, a file blockchain transactions is constructed, and the constructed file blockchain transactions is sent to the blockchain network to be recorded.

2. The structured work is a musical work.

When the structured work is a musical work, for each of the component contents, the component content can be an audio track file corresponding to the musical work. The client device assigns a label to the component content, and can use a track number corresponding to the component content which is predetermined by the user as the label corresponding to the component content.

After the user completes the creation of the structured work via the client device, the client device can determine the sequence of the component contents based on the track numbers respectively corresponding to the component contents; based on the sequence of the component contents, sort the component hashes respectively corresponding to the component contents to obtain a second sequence; construct a Merkle tree based on the second sequence; construct a file blockchain transactions based on the root hash corresponding to the root node of the Merkle tree, and send the constructed file blockchain transactions to the blockchain network to be recorded.

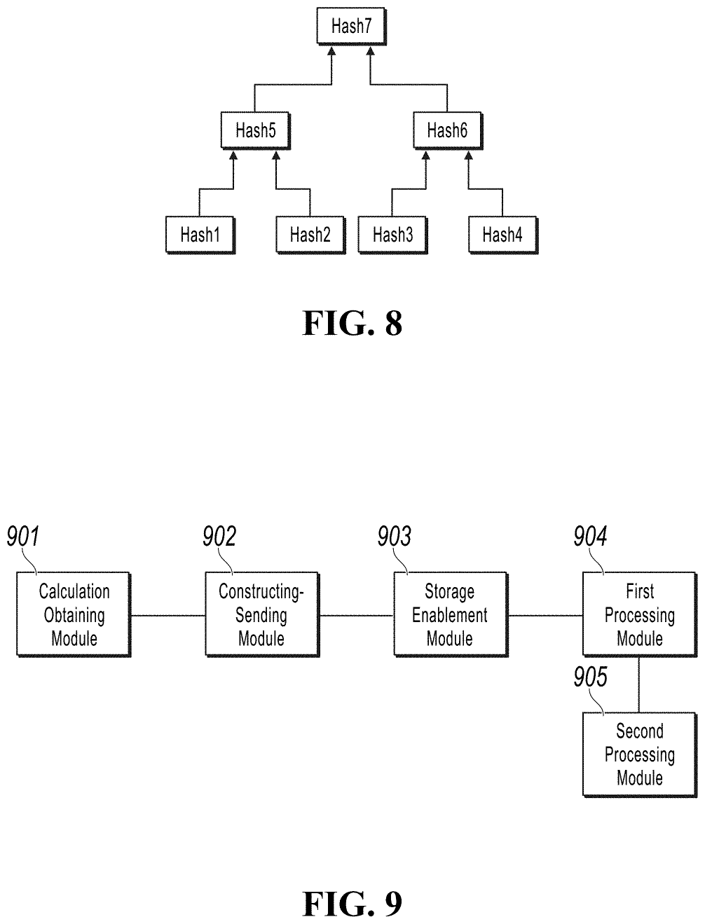

FIG. 8 is a schematic diagram of a Merkle tree corresponding to a musical work according to an example of the present specification. As shown in FIG. 8, hash1˜hash4 are respectively the component hashes corresponding to the track files 1˜4 of the music work. Hash5 is obtained by hash calculation on hash1 and hash4, hash6 is obtained by hash calculation on hash3 and hash4, and hash7 is obtained by hashing hash5 and hash6.

When the user modifies any of the component contents in the structured work via the client device, the Merkle tree can be updated based on the component hash of the modified component content; then, based on the root hash corresponding to the root node of the updated Merkle tree, a file blockchain transactions can be constructed and the constructed file blockchain transactions can be sent to the blockchain network to be recorded.

When the user adds any of the component contents to the structured work via the client device, the component hash corresponding to the component content is inserted to the ending part of the second sequence; based on the updated second sequence, the Merkle tree is updated; then a file blockchain transactions can be constructed based on the root hash corresponding to the root node of the updated Merkle tree, and the constructed file blockchain transactions can be sent to the blockchain network to be recorded.

For details, reference can be made to the relevant description of the text above, and the policies are similar, details are omitted for simplicity.

In addition, regardless of whether the structured work is a text or a musical work, when the user adds any of the component contents to the structured work via the client device, the client device can calculate the component hash of the component content; based on this component hash, construct the component blockchain transactions corresponding to the component content, and send the component blockchain transactions corresponding to the component content to the blockchain network to be recorded; and establish and store a correspondence between the component content and the structured work.

Also, for the component blockchain transactions corresponding to each of the component contents, the client device establishes and stores the correspondence between the transaction hash of the component blockchain transactions and the transaction hash of the constructed file blockchain transactions. In this way, a mapping between structured works and the component contents can be established at the level of blockchain transaction.

In addition, in practice, every time a user modifies a structured work, the modification can be recorded on the device. Specifically, the root hash corresponding to the structured work after each modification by the user can be recorded, which is equivalent to recording each replacement version of the structured work during the entire process of creating the structured work by the user.

FIG. 9 is a block diagram illustrating an blockchain-based apparatus for recording a structured work according to an example of the present specification, and the apparatus includes:

a calculation obtaining module 901 configured to, in a process of a user creating a structured work via a client device, for each of the component contents created by the user, obtain the component content and calculate a component hash of the component content;

a constructing-sending module 902 configured to, based on the component hash, construct a component blockchain transactions corresponding to the component content, and send the component blockchain transactions corresponding to the component content to a blockchain network to be recorded;

a storage enablement module 903 configured to establish and store a correspondence between the component content and the structured work.

The storage enablement module 903 is configured to assign a label to the component content, where the label corresponding to the component content contains a work identifier of the structured work; and store the label corresponding to the component content.

The storage enablement module 903 is configured to establish and store a correspondence between the label corresponding to the component content and a transaction hash of the component blockchain transactions corresponding to the component content.

The structured work is a text; for each of the component contents created by the user, the component content is a paragraph of the text.

The storage enablement module 903 is configured to use the paragraph path corresponding to the component content which is predetermined by the user, as the label corresponding to the component content.

The apparatus also includes:

a first processing module 904 configured to, after the user completes the creation of the structured work via the client device, determine a sequence of the component contents in the structured work based on the paragraph paths respectively corresponding to the component contents; based on the sequence of the component contents, sort the component hashes respectively corresponding to the component contents, to obtain a first sequence; based on the first sequence, construct a hash tree, where in the hash tree, the root node corresponds to the structured work, and leaf nodes have one-to-one correspondence to component hashes, and for each of the leaf nodes, the path between the root node and the leaf node is consistent with the paragraph path of the component hash corresponding to the leaf node; based on the root hash corresponding to the root node of the hash tree, construct a file blockchain transactions; and send the constructed file blockchain transactions to the blockchain network to be recorded.

The first processing module 904 is configured to, when the user modifies any of the component contents in the structured work via the client device, update the hash tree based on the component hash of the modified component content; based on the root hash corresponding to the root node of the updated hash tree, construct a file blockchain transactions and send the constructed file blockchain transactions to the blockchain network to be recorded.

The first processing module 904 is configured to, when the user adds any of the component contents to the structured work via the client device, based on the paragraph path corresponding to the component content which is predetermined by the user, determine a sequence of the component hash corresponding to the component content relative to each component hash in the first sequence; based on the sequence of the component hash corresponding to the component content relative to each component hash in the first sequence, insert the component hash corresponding to the component content to the first sequence; based on the updated sequence, update the hash tree; based on the root hash corresponding to the root node of the updated hash tree, construct a file blockchain transactions, and send the constructed file blockchain transactions to the blockchain network to be recorded.

The structured work is a musical work edited based on a sequencer; for each of the component contents created by the user, the component content is an audio track file corresponding to the musical work.

The storage enablement module 903 is configured to use a track number corresponding to the component content as the label corresponding to the component content.

The apparatus further includes:

a second processing module 905 configured to, after the user completes the creation of the structured work via the client device, determine a sequence of the component contents based on the track numbers respectively corresponding to the component contents; based on the sequence of the component contents, sort the component hashes respectively corresponding to the component contents to obtain a second sequence; construct a Merkle tree based on the second sequence; construct a file blockchain transactions based on the root hash corresponding to the root node of the Merkle tree, and send the constructed file blockchain transactions to the blockchain network to be recorded.

The second processing module 905 is configured to, when the user modifies any of the component contents in the structured work via the client device, update the Merkle tree based on the component hash of the modified component content; based on the root hash corresponding to the root node of the updated Merkle tree, construct a file blockchain transactions and send the constructed file blockchain transactions to the blockchain network to be recorded.

The second processing module 905 is configured to, when the user adds any of the component contents to the structured work via the client device, insert the component hash corresponding to the component content to the ending part of the second sequence; based on the updated second sequence, update the Merkle tree; construct a file blockchain transactions based on the root hash corresponding to the root node of the updated Merkle tree, and send the constructed file blockchain transactions to the blockchain network to be recorded.

The calculation obtaining module 901 is configured to, when the user adds any of the component contents to the structured work via the client device, calculate a component hash of the component content.

The constructing-sending module 902 is configured to, based on the component hash, construct a component blockchain transactions corresponding to the component content, and send the component blockchain transactions corresponding to the component content to the blockchain network to be recorded.

The storage enablement module 903 is configured to establish and store a correspondence between the component content and the structured work.

The storage enablement module 903 is configured to, for the component blockchain transactions corresponding to each of the component contents, establish and store a correspondence between the transaction hash of the component blockchain transactions and the transaction hash of the constructed file blockchain transactions.

Some examples of the present specification also provide a computer device, which includes at least a memory, a processor, and a computer program stored in the memory and running on the processor, wherein when the processor executes the program, the processor implements the function of the method as shown in FIG. 1.

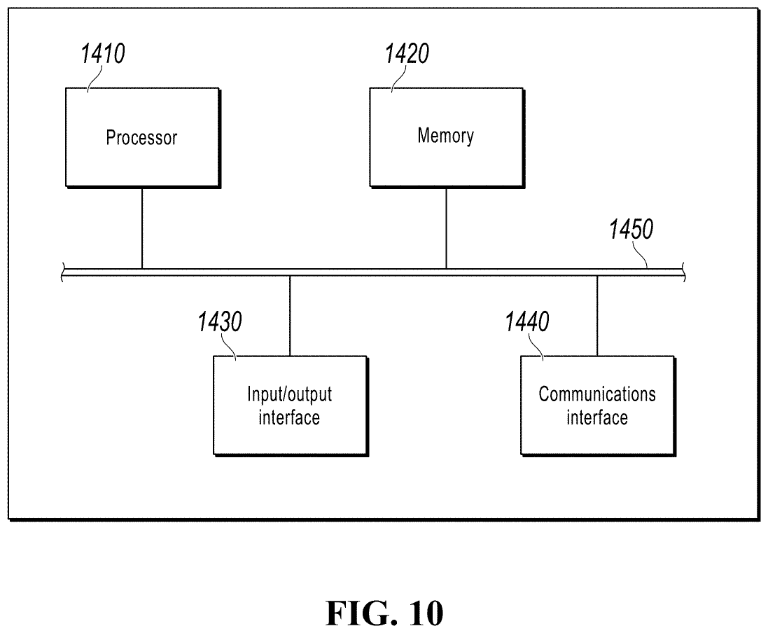

FIG. 10 shows a more specific hardware structure diagram of a computing device according to an example of the present specification. The device can include a processor 1410, a memory 1420, an input/output interface 1430, a communication interface 1440, and a bus 1450. The processor 1410, the memory 1420, the input/output interface 1430, and the communication interface 1440 implement communication connection between one another in the device via the bus 1450.

The processor 1410 can be implemented by a general Central Processing Unit (CPU), a microprocessor, an Application Specific Integrated Circuit (ASIC), or one or more integrated circuits, to execute related programs to implement the technical solutions provided in some examples of the present specification.

The memory 1420 can be implemented in the form of Read Only Memory (ROM), Random Access Memory (RAM), a static storage device, a dynamic storage device, or the like. The memory 1420 can store an operating system and other application programs. When the technical solutions provided in some examples of the present specification are implemented by software or firmware, the related program codes are stored in the memory 1420 and invoked and executed by the processor 1410.

The input/output interface 1430 is configured to be connected to input/output modules to implement information input and output. The input/output modules can be configured in the device as components (not shown in the figures), or can be connected externally to a device to provide corresponding functions. Ae input device can include a keyboard, a mouse, a touch screen, a microphone, various sensors, or the like, and an output device can include a display, a speaker, a vibrator, an indicator light, or the like.

The communication interface 1440 is configured to be connected to a communication module (not shown in the figures) to implement communication interaction between the device and other devices. The communication module can implement communication through wired means (such as USB, network cable, or the like), or through wireless means (such as mobile network, WIFI, Bluetooth, or the like).

The bus 1450 includes a path to transmit information between various components of the device (for example, the processor 1410, the memory 1420, the input/output interface 1430, and the communication interface 1440).

It should be noted that although the above device only is shown to have the processor 1410, the memory 1420, the input/output interface 1430, the communication interface 1440, and the bus 1450, in the specific implementation process, the device can also include other components required to implement normal operation. In addition, those skilled in the art can understand that the above device can also include only the components necessary to implement the solutions of some examples of the present specification, and not necessarily include all the components shown in the figures.

Some examples of the present specification also provide a computer-readable storage medium on which a computer program is stored, and when the program is executed by a processor, the function of the method shown in FIG. 3 is implemented.

The computer-readable medium includes persistent, non-persistent, removable or non-removable medium, which can store information by any method or technology. Information can be computer-readable instructions, data structures, modules of a program, or other data. Examples of computer storage media include, but are not limited to, a parameter random access memory (PRAM), a static random access memory (SRAM), a dynamic random access memory (DRAM), other types of random access memory (RAM), and a read-only memory (ROM), an electrically erasable programmable read-only memory (EEPROM), a flash memory or other memory technologies, a compact disc read-only memory (CD-ROM), a digital versatile disc (DVD) or other optical storage, a cassette magnetic tape, magnetic disk storage, a quantum memory, graphene-based storage media, or other magnetic storage devices or any other non-transmission media can be used to store information that can be accessed by computing devices. Based on the definition in the present specification, computer-readable media does not include transitory computer-readable media (transitory media), such as modulated data signals and carrier waves.

From the description of the above examples, those skilled in the art can clearly understand that some examples of the present specification can be implemented by means of software plus a necessary general hardware platform. Based on this understanding, the technical solutions of some examples of the present specification can be embodied in the form of software products, which can be stored in storage media, such as ROM/RAM, a magnetic disk, an optical disk, etc., include several instructions to make a computer device (which can be a personal computer, a server, or a network device, etc.) to execute the methods described in the various examples or some parts of some examples of the present specification.

The system, apparatus, module, or unit described in the previous examples can be implemented by a computer chip or entity, or can be implemented by using a product with a certain function. A typical implementation device is a computer, and the specific form of the computer can be a personal computer, a laptop computer, a cellular phone, a camera phone, a smart phone, a personal digital assistant, a media player, a navigation device, an email sending and receiving device, a game console, a tablet computer, a wearable device, or a combination of any of these devices.

The various examples in the present specification are described in a progressive manner, and the same or similar parts between the various examples can be referred to each other. Each example focuses on the differences from other examples. In particular, for the method and device examples, since they are basically similar to the method examples, the description is relatively simple, and the relevant parts can be referred to the part of the description of the method examples. The method examples described above are only illustrative. The modules described as separate components can or cannot be physically separated. When implementing the solutions of some examples of the present specification, the functions of the modules can be in the same or multiple software and/or hardware implementations. Some or all of the modules can also be selected according to actual needs to achieve the objectives of the solutions of some examples. Those of ordinary skill in the art can understand and implement it without creative work.

The above are only specific implementations of some examples of the present specification. It should be pointed out that for those of ordinary skill in the art, without departing from the principle of some examples of the present specification, some improvements and modifications can be made. Such improvements and modifications should also be regarded as be within the protection scope of some examples of the present specification.

1. A computer-implemented method for blockchain-based data recording, comprising:
identifying, by a client device, one or more components of a structured work created by a user;
for each component of the one or more components:
calculating, by the client device, a hash value of the component;
constructing, by the client device based on the hash value, a component blockchain transaction corresponding to the component, and
sending, by the client device, the component blockchain transaction to a blockchain network to be recorded; and
recording, by the client device, a correspondence between the component and the structured work.

2. The method of claim 1, wherein recording the correspondence between the component and the structured work comprises:
for each component of the one or more components:
assigning, by the client device, a label to the component, wherein the label comprises an identifier of the structured work; and
recording, by the client device, the label.

3. The method of claim 2, further comprising:
for each component of the one or more components:
recording, by the client device, a hash value of the component blockchain transaction corresponding to the component.

4. The method of claim 2, wherein the structured work is a piece of text, the one or more components are one or more paragraphs of the piece of text, and assigning the label to the component comprises:
for each component of the one or more components:
using, by the client device, a paragraph path predetermined by the user corresponding to the component as the label.

5. The method of claim 4, further comprising:
determining, by the client device, an order of the one or more components based on the paragraph path of each of the one or more paragraphs corresponding to the one or more components;
sorting, by the client device based on the order of the one or more components, the hash value of each of the one or more components to obtain a hash sequence;
constructing, by the client device based on the hash sequence, a hash tree, wherein a root node of the hash tree corresponds to the structured work, each leaf node corresponds to the hash value of each of the one or more components, and a path between the root node and the leaf node is determined based on the paragraph path;
constructing, by the client device and based on a root hash corresponding to the root node of the hash tree, a file blockchain transaction; and
sending, by the client device, the file blockchain transaction to the blockchain network to be recorded.

6. The method of claim 5, further comprising:
detecting, by the client device, that a component of the one or more components is modified;
calculating, by the client device, a hash value of the modified component;
updating the hash tree based on the hash value of the modified component;
constructing, by the client device based on the root hash, an updated file blockchain transaction; and
sending, by the client device, the updated file blockchain transaction to the blockchain network to be recorded.

7. The method of claim 5, further comprising:
detecting, by the client device, that a component of the one or more components is modified;
calculating, by the client device, a hash value of the modified component;
determining, by the client device based on a paragraph path corresponding to the modified component, a position of the hash value of the modified component relative to hash values in the hash sequence;
inserting, by the client device, the hash value of the modified component to the hash sequence to generate an updated hash sequence;
updating, by the client device based on the updated hash sequence, the hash tree;
constructing, by the client device based on the root hash, an updated file blockchain transaction; and
sending the updated file blockchain transaction to the blockchain network to be recorded.

8. The method of claim 2, wherein the structured work is a musical work edited based on a sequencer, the one or more components are one or more audio tracks of the musical work, and assigning the label to the component comprises:
assigning a track number as the label to the component.

9. The method of claim 8, further comprising:
determining, by the client device, an order of the one or more components based on the track number of each of the one or more audio tracks corresponding to the one or more components;
sorting, by the client device based on the order of the one or more components, the hash value of each of the one or more components to obtain a hash sequence;
constructing, by the client device based on the hash sequence, a Merkle tree;
constructing, by the client device and based on a root hash corresponding to a root node of the Merkle tree, a file blockchain transaction; and
sending, by the client device, the file blockchain transaction to the blockchain network to be recorded.

10. The method of claim 9, further comprising:
detecting, by the client device, that a component of the one or more components is modified;
calculating, by the client device, a hash value of the modified component;
updating the Merkle tree based on the hash value of the modified component;
constructing, by the client device based on the root hash, an updated file blockchain transaction; and
sending, by the client device, the updated file blockchain transaction to the blockchain network to be recorded.

11. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
identifying, by a client device, one or more components of a structured work created by a user;
for each component of the one or more components:
calculating, by the client device, a hash value of the component;
constructing, by the client device based on the hash value, a component blockchain transaction corresponding to the component, and
sending, by the client device, the component blockchain transaction to a blockchain network to be recorded; and
recording, by the client device, a correspondence between the component and the structured work.

12. The computer-implemented system of claim 11, wherein recording the correspondence between the component and the structured work comprises:
for each component of the one or more components:
assigning, by the client device, a label to the component, wherein the label comprises an identifier of the structured work; and
recording, by the client device, the label.

13. The computer-implemented system of claim 12, further comprising:
for each component of the one or more components:
recording, by the client device, a hash value of the component blockchain transaction corresponding to the component.

14. The computer-implemented system of claim 12, wherein the structured work is a piece of text, the one or more components are one or more paragraphs of the piece of text, and assigning the label to the component comprises:
for each component of the one or more components:
using, by the client device, a paragraph path predetermined by the user corresponding to the component as the label.

15. The computer-implemented system of claim 14, further comprising:
determining, by the client device, an order of the one or more components based on the paragraph path of each of the one or more paragraphs corresponding to the one or more components;
sorting, by the client device based on the order of the one or more components, the hash value of each of the one or more components to obtain a hash sequence;
constructing, by the client device based on the hash sequence, a hash tree, wherein a root node of the hash tree corresponds to the structured work, each leaf node corresponds to the hash value of each of the one or more components, and a path between the root node and the leaf node is determined based on the paragraph path;
constructing, by the client device and based on a root hash corresponding to the root node of the hash tree, a file blockchain transaction; and
sending, by the client device, the file blockchain transaction to the blockchain network to be recorded.

16. The computer-implemented system of claim 15, further comprising:
detecting, by the client device, that a component of the one or more components is modified;
calculating, by the client device, a hash value of the modified component;
updating the hash tree based on the hash value of the modified component;
constructing, by the client device based on the root hash, an updated file blockchain transaction; and
sending, by the client device, the updated file blockchain transaction to the blockchain network to be recorded.

17. The computer-implemented system of claim 15, further comprising:
detecting, by the client device, that a component of the one or more components is modified;
calculating, by the client device, a hash value of the modified component;
determining, by the client device based on a paragraph path corresponding to the modified component, a position of the hash value of the modified component relative to hash values in the hash sequence;
inserting, by the client device, the hash value of the modified component to the hash sequence to generate an updated hash sequence;
updating, by the client device based on the updated hash sequence, the hash tree;
constructing, by the client device based on the root hash, an updated file blockchain transaction; and
sending the updated file blockchain transaction to the blockchain network to be recorded.

18. The computer-implemented system of claim 12, wherein the structured work is a musical work edited based on a sequencer, the one or more components are one or more audio tracks of the musical work, and assigning the label to the component comprises:
assigning a track number as the label to the component.

19. The computer-implemented system of claim 18, further comprising:
determining, by the client device, an order of the one or more components based on the track number of each of the one or more audio tracks corresponding to the one or more components;
sorting, by the client device based on the order of the one or more components, the hash value of each of the one or more components to obtain a hash sequence;
constructing, by the client device based on the hash sequence, a Merkle tree;
constructing, by the client device and based on a root hash corresponding to a root node of the Merkle tree, a file blockchain transaction; and
sending, by the client device, the file blockchain transaction to the blockchain network to be recorded.

20. A non-transitory, computer-readable medium storing one or more instructions executable by a computer system to perform operations comprising:
identifying, by a client device, one or more components of a structured work created by a user;
for each component of the one or more components:
calculating, by the client device, a hash value of the component;
constructing, by the client device based on the hash value, a component blockchain transaction corresponding to the component, and
sending, by the client device, the component blockchain transaction to a blockchain network to be recorded; and
recording, by the client device, a correspondence between the component and the structured work.
